(19) United States
(12) Patent Application Publication
(10) Pub. No.: US 2017/0372642 A1
(43) Pub. Date: Dec. 28, 2017

(54) SYSTEM AND METHOD FOR CREATING PRECISION AGRICULTURE DATA MAPS

(71) Applicant: Terry Hofecker, Irwin, OH (US)

(72) Inventor: Terry Hofecker, Irwin, OH (US)

(21) Appl. No.: 15/195,094

(22) Filed: Jun. 28, 2016

(51) Int. Cl. G09B 29/00

(52) U.S. Cl. CPC G09B 29/007

(57) ABSTRACT

A method for creating precision agriculture data maps utlilizing one or more hand-carried or vehicle transported mobile sensors that feed various types of agriculture-related soil and plant measurements into a mobile processing device that has software that automatically plots the data geospatially and contours the data readings in color-coded or shaded gradients that can be displayed in layers and that can be saved and compared over time.

### BACKGROUND AND SUMMARY

The present invention relates generally to data acquisition and presentation systems and methods and more specifically to such systems and methods of graphically representing geographic data. In one embodiment, the present invention is a method of using mobile sensors to feed data to a field portable data processing unit that can locate the data spatially and render the data values in a color-coded or shaded map that would not require a substantial degree of literacy to use.

In order to make precision agriculture technology available to the developing world or to diffuse it more rapidly in the developed world, it is necessary to reduce the cost of gathering, processing, rendering and preserving relevant data. Sensors are often individually inexpensive but if they are placed in fixed positions, many hundreds of them are needed to provide data from even small fields. If this data can be fed into an inexpensive portable data processing device, such as a smart phone with GPS or GLONASS capability, and quickly and efficiently processed into values-contoured maps, every farmer who can afford this inexpensive system will be empowered to produce detailed, time-delineated maps that are presently only available from agricultural consultants and laboratories.

If the data is processed in the field on devices such as smart phones, tablets, laptop computers or special portable data processing that have wireless, cellular or satellite connectivity, the resultant maps can be uploaded to the cloud for storage and later analysis. Because the data is rendered on a color-coded or shaded map, alphanumeric literacy is not required. Thus, language and educational barriers are circumvented.

The present invention provides a single hardware-software system that can serve multiple farmers in a locality, reducing cost and increasing accessibility to precision agriculture practices. Because the maps are automatically scalable, a North American farmer with large fields could walk or drive an ATV, tractor or truck and create maps of whatever resolution he or she chose. In short, such a small, field portable hardware-software system would empower individual farmers or small groups of farmers all over the world to be their own crop consultants and analysts and to conserve fresh water, fertilizer, soil augmentation minerals and pesticides. For crops such as potatoes that require specific soil chemistry, moisture and temperature conditions, optimal growth could be achieved in areas where additional food sources are needed.

The present invention can increase yields while reducing costs and fresh water use. Presently, the data sets needed to drive these practices require highly trained individuals and expensive equipment to produce. Often, as in soil sampling, the ground resolution is low (one sample per 2.5 acres on average) and the data often has latency, both in time to return from that laboratory and in how often these expensive samples can be taken. In some parts of the world the infrastructure to do these tests does not exist at all. If a low cost method is made available to every individual farmer, food productivity and farming profitability could increase worldwide. If that data is rendered in a non-alphanumeric manner, these practices could be more easily translated into marginal areas where there is the greatest need and literacy is very low.

Ground/soil data is gathered relating to moisture, temperature, pH, acidity, alkalinity, conductivity, and dielectric permittivity, utilizing various methods, including without limitation: coaxial impedance dielectric reflectometry, frequency domain reflectometry, time domain reflectometry, frequency capacitance, and soil electrical conductivity, and displayed on a map according to GPS coordinates, topography, and latitude & longitude.

In one embodiment, a pedestrian traverses a field and manually inserts the probe into the ground. In other embodiments, manned or unmanned ground vehicles, can be used to gather data.

One advantage of the present invention is that uneducated or illiterate persons can utilize some embodiments of the invention because the measured data is displayed using non-alphanumeric indicia such as colors and shapes. However, other embodiments are possible wherein alphanumeric indicia are utilized.

In one embodiment, the present invention is implemented using an Arduino system and temperature & moisture sensor wand wherein the system reads the temperature and soil moisture levels at a given GPS location and records those values as a *.csv file on a microSD card. The GPS, Real Time Clock (RTC), and SD card port are all a part of the Adafruit Ultimate GPS Data Logger Shield. A subroutine can be utilized to open and write to two files, or alternatively only one file can be written to in order to save space.

### BRIEF DESCRIPTION OF THE DRAWINGS

FIG. 1 depicts a geographic representation of a dataset

FIG. 2 depicts a flow diagram of one embodiment of the invention

FIG. 3 depicts a block diagram of one embodiment of the invention

FIG. 4 depicts a block diagram of an alternative embodiment of the invention

### DETAILED DESCRIPTION

In one embodiment, a method for creating an agriculture data map comprises utlilizing one or more hand-carried or vehicle transported mobile sensors (aka measurement device 2) that feed various types of agriculture-related soil and plant measurements 8 into a mobile processing device 2 that has software that automatically plots the data geospatially and contours the data readings in color-coded or shaded gradients that can be displayed in layers and that can be saved and compared over time.

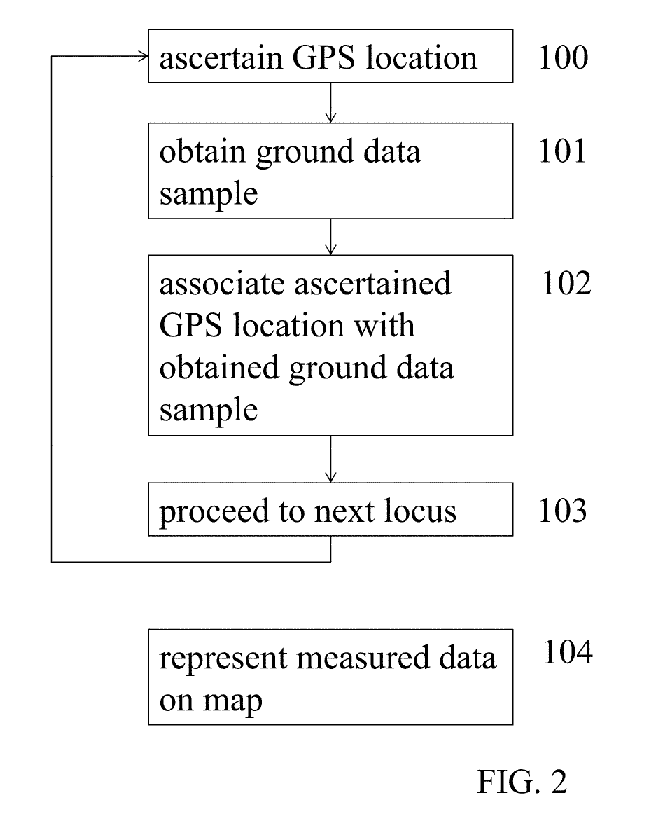

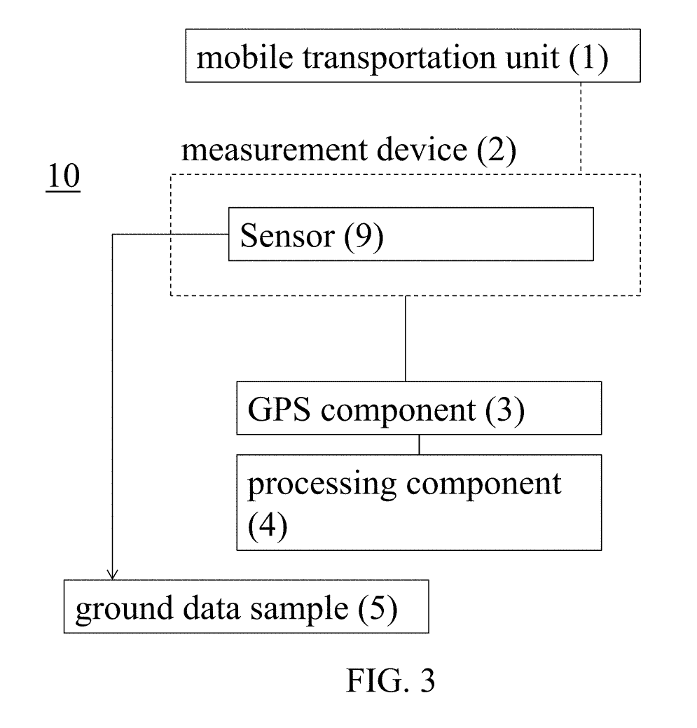

In one embodiment (FIGS. 2, 3) a method for creating an agriculture data map comprises the steps of, utilizing a system 10 comprising, mobile transportation unit 1, measurement device 2, GPS component 3, and processing component 4; the mobile transportation unit 1 sequentially obtaining a plurality of ground data samples (101, 103) in selected geographic region 6 by temporarily inserting measurement device 2 into a selected locus 7 of the geographic region; the GPS component 3 ascertaining the GPS coordinates of each of said selected loci 100; and the processing component 4 associating each of said data samples with a single locus of the loci 102; whereby each of the data samples can be geographically represented according to the locus of each said data sample.

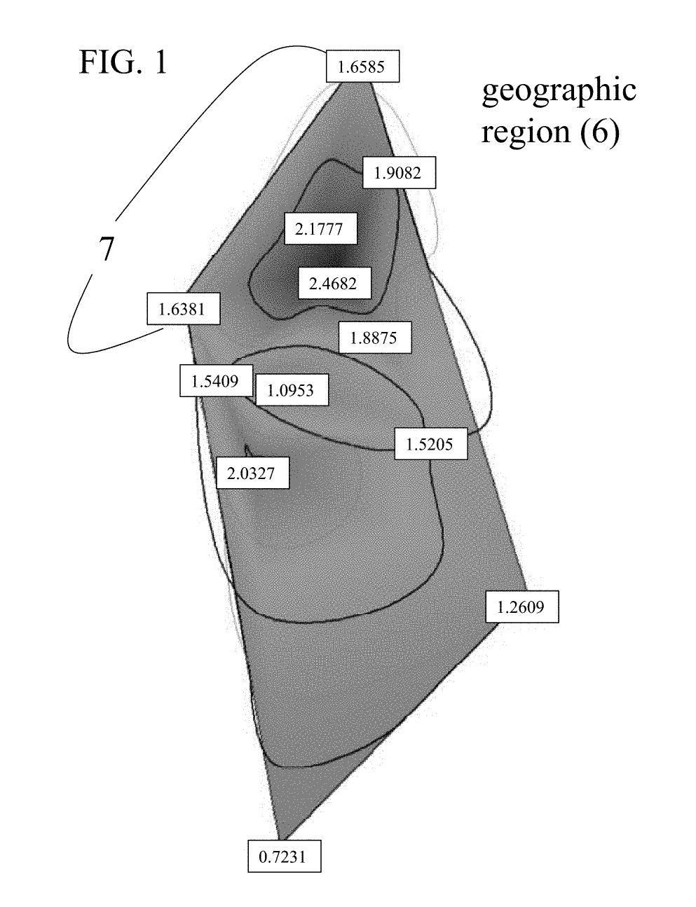

In one embodiment, a map (FIG. 1) is used to graphically represent the measured data. The map depicts the geographic area and may or may not overlay the topography of the area. Measured data relating to ground moisture is numerically represented on the map. The unit of measurement on the moisture sensor plot is volts. The readings go from 0-3V, with zero (0) Volts indicating no moisture and 3 Volts indicating standing water. The data is correlated to volumetric water content (VWC) depending on the soil type.

The measured data values are correlated to colors to realize a color interpolation space. In FIG. 1, the color interpolation space was set to Brown-Green-Blue for 0 to 3 Volts, respectively. i.e. a measured value of 0 Volts is depicted as the color brown (no ground moisture) and a measured value of 3 Volts (standing water) is depicted as blue. In FIG. 1, the data values range from 0.7231 to 2.4682.

It should be noted that each and every measured data point can be represented, or alternatively the measured data can be represented in the aggregate. For instance, on a given map, every data point can be listed. Alternatively, every other data point can be listed and color gradients can be used to represent the non-listed data points. The following graphical indicia can be used to represent the measured data on a map: colors, color gradients, lines, numbers, symbols, line types, stippling, or hatching.

Mobile transportation unit 1 sequentially obtains a plurality of ground data samples (FIG. 2: 101, 103) in a selected geographic region 6 by temporarily inserting sensor 9 of measurement device 2 into selected loci 7 of the geographic region.

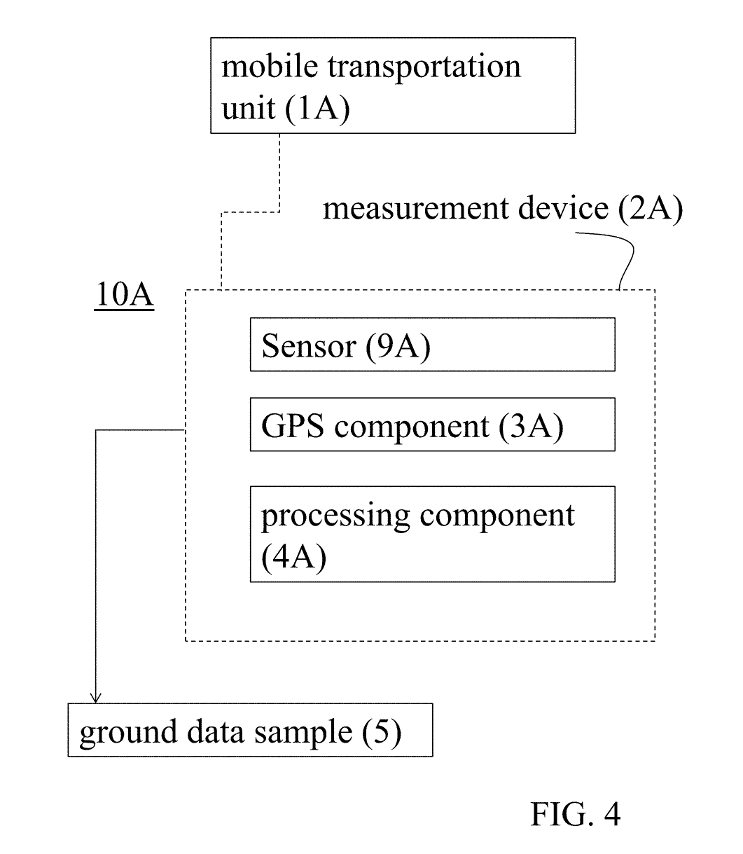

It is to be noted that sensor 9, 9A, GPS component 3, 3A, and processing component 4, 4A can be contained within a single system as shown by measurement device 2A, in FIG. 4 (e.g. mobile device, smart phone) or alternatively can exist separately as shown in FIG. 3 wherein the various components are interconnected in various ways (e.g. hard wired or wireless such as wifi, Bluetooth, etc.). Regarding the latter (FIG. 3), the interconnectivity and cooperation of the various components is analogous to the foregoing description regarding FIG. 3. Those of skill in the art will appreciate that sensor 9, 9A, regardless of the various configurations described, includes a probe or probes that is contacted with, or inserted within, the ground.

Sufficient processing and memory is provided such that GPS component 3, 3A can ascertain the GPS coordinates and process the information in a meaningful way. A typical mobile phone has such capability. The measured ground sample data 101 comprises any one or more of the following data types: temperature, soil moisture level, pH, acidity, alkalinity, impedance, or dielectric permittivity.

It is to be noted that sufficient time is spent at a specific locus to allow GPS component 3, 3A to ascertain the current GPS coordinates. This can be accomplished by providing feedback (via processing component 4, 4A, or via GPS component 3, 3A) to mobile transportation unit 1, 1A to ensure the locus is properly matched to the measured data. For instance, mobile transportation unit 1 comprises a pedestrian in one embodiment, who does not proceed to the next locus until a light, or sound, indicates that the GPS coordinates have been ascertained and associated with the measured data. The pedestrian then proceeds to the next locus, and inserts sensor 9, 9A into the ground and waits for the measured data to be matched to the newly ascertained GPS coordinate.

In one embodiment, GPS processing component 3, 3A ascertains the geographic location of each of said loci contemporaneously with the insertion of the measurement device into each of said loci. However, other ways are possible. For instance, the loci can be pre-marked at known GPS coordinates to be later-traversed by mobile transportation unit 1, 1A. It should be noted that the term “contemporaneously” in this case is defined as being relatively close in time. Thus, it should not be construed to mean at precisely the same time.

In one embodiment, processing component 4, 4A associates each of the data samples with the single locus of the loci contemporaneously with the insertion of the measurement device into each of said loci. However, alternative embodiments are possible. For instance, mobile transportation unit 1 traverses each locus in a predetermined order. The GPS coordinates of each locus have been separately ascertained and marked in the geographic region. Thus, the measured data and GPS coordinates can be matched at a later time.

In one embodiment, mobile transportation unit 1 comprises a pedestrian (aka a person on foot). Alternatively, the invention could be carried out by a robot, or a person using some mode of transportation (e.g. animal).

In one embodiment, system 10 consists of no more than one measurement device 2 which is carried by a pedestrian 1 and manually temporarily inserted into each locus for a time interval sufficient to allow a data measurement.

What is claimed is:

1. A method for creating an agriculture data map comprising:
utlilizing one or more hand-carried or vehicle transported mobile sensors that feed various types of agriculture-related soil and plant measurements into a mobile processing device that has software that automatically plots the data geospatially and contours the data readings in color-coded or shaded gradients that can be displayed in layers and that can be saved and compared over time.

2. A method for creating an agriculture data map comprising the steps of:
utilizing a system comprising:
a mobile transportation unit, a measurement device, a GPS component, and a processing component;
the mobile transportation unit sequentially obtaining a plurality of ground data samples in a selected geographic region by temporarily inserting the measurement device into selected loci of said geographic region;
the GPS component ascertaining the GPS coordinates of each of said selected loci;
the processing component associating each of said data samples with a single locus of the loci;
whereby each of said data samples can be geographically represented according to the locus of each said data sample.

3. The method of claim 2 further comprising:
the ground sample data comprising any one or more data types:
temperature, soil moisture level, pH, acidity, alkalinity, impedance, dielectric permittivity.

4. The method of claim 2 further comprising:
the temporary time interval of insertion of the measurement device is less than 1 second.

5. The method of claim 2 further comprising:
the GPS processing component ascertaining the geographic location of each of said loci contemporaneously with the insertion of the measurement device into each of said loci.

6. The method of claim 2 further comprising:
the processing component associating each of said data samples with the single locus of the loci contemporaneously with the insertion of the measurement device into each of said loci.

7. The method of claim 2 further comprising:
displaying a map of said geographic region;
representing said data samples on the map.

8. The method of claim 7 further comprising:
representing said data samples on the map according to any one or more of
colors, color gradients, lines, numbers, symbols, line types, stippling, or hatching.

9. The method of claim 2 further comprising:
said graphical indicia comprising any one or more of
colors, color gradients, lines, numbers, symbols, line types, stippling, or hatching.

10. The method of claim 2 further comprising:
said GPS processing component comprising a mobile electronic device.

11. The method of claim 2 further comprising:
the GPS component and the processing component being incorporated into the measurement device.

12. The method of claim 2 further comprising:
the mobile transportation unit comprising a pedestrian.

13. The method of claim 2 further comprising:
the mobile transportation unit comprising a robot.

14. A method for creating an agriculture data map comprising the steps of:
utilizing a system consisting of:
a pedestrian,
a measurement device,
a GPS component,
and a processing component;
the pedestrian sequentially obtaining a plurality of ground data samples in a selected geographic region by temporarily inserting the measurement device into selected loci of said geographic region;
the GPS component ascertaining the GPS coordinates of each of said selected loci;
the processing component associating each of said data samples with a single locus of the loci.

15. The method of claim 14 further comprising:
displaying a map of said geographic region;
graphically representing each of said data samples, according to the locus of said data sample, on said map.

16. The method of claim 15 further comprising:
each of said data samples representative of a measured voltage, within a voltage range, at one of said loci;
graphically representing each of said data samples according to a
color gradient associated with the voltage range.

17. The method of claim 15 further comprising:
said GPS processing component comprising a mobile electronic device.
